(19) United States
(12) Patent Application Publication
(10) Pub. No.: US 2023/0020586 A1
(43) Pub. Date: Jan. 19, 2023

(54) CARRIER AGGREGATION WITH INTEGRATED FILTERS

(71) Applicant: SKYWORKS SOLUTIONS, INC., Irvine, CA (US)

(72) Inventors: Reza KASNAVI, Solana Beach, CA (US); Jianxing NI, San Jose, CA (US); Jeffrey Gordon STRAHLER, Greensboro, NC (US); Yang HOU, San Jose, CA (US); Shao?Min HSU, San Jose, CA (US)

(21) Appl. No.: 17/851,168

(22) Filed: Jun. 28, 2022

Related U.S. Application Data
(60) Provisional application No. 63/216,388, filed on Jun. 29, 2021.

(51) Int. Cl. H04L 5/00

(52) U.S. Cl. CPC H04L 5/0098; H04L 5/0053; H04L 5/0073; H04L 5/0094

(57) ABSTRACT

In some embodiments, a front-end system can include a switch network that includes an antenna node, a first signal node connectable to a first filter-based assembly for a first band, a second signal node connectable to a second filter-based assembly for a second band, and a third signal node connectable to a third filter-based assembly for a third band. The switch network can be configured to support carrier aggregation of at least the first and second bands. The front-end system can further include a reconfigurable routing circuit configured to allow carrier aggregation of the third band and a selected one of the first and second bands utilizing the third filter-based assembly and the filter-based assembly associated with the selected one of the first and second bands.

### CROSS-REFERENCE TO RELATED APPLICATION(S

This application claims priority to U.S. Provisional Application No. 63/216,388 filed Jun. 29, 2021, entitled CARRIER AGGREGATION WITH INTEGRATED FILTERS, the disclosure of which is hereby expressly incorporated by reference herein in its respective entirety.

### BACKGROUND

### Field

The present disclosure relates to carrier aggregation of radio-frequency signals.

### Description of the Related Art

In many communication systems and devices, carrier aggregation of signals in different band can be utilized to accommodate growing band coverage, need for increased throughput, etc. In such systems and devices, complexity of radio-frequency (RF) front-end designs can increase significantly.

### SUMMARY

In accordance with a number of implementations, the present disclosure relates to a front-end system that includes a switch network that includes an antenna node, a first signal node connectable to a first filter-based assembly for a first band, a second signal node connectable to a second filter-based assembly for a second band, and a third signal node connectable to a third filter-based assembly for a third band. The switch network is configured to support carrier aggregation of at least the first and second bands. The front-end system further includes a reconfigurable routing circuit configured to allow carrier aggregation of the third band and a selected one of the first and second bands utilizing the third filter-based assembly and the filter-based assembly associated with the selected one of the first and second bands.

In some embodiments, the front-end system can further include the first filter-based assembly connected to the first signal node, the second filter-based assembly connected to the second node, and the third filter-based assembly connected to the third node.

In some embodiments, at least a portion of the reconfigurable routing circuit can be part of the switch network.

In some embodiments, each of the first and second filter-based assemblies can include a duplexer configured to support duplex operation involving transmit and receive portions of the respective band. The third filter-based assembly can include a duplexer configured to support duplex operation involving transmit and receive portions of the third band. The third filter-based assembly can include a filter configured to support a transmit or receive portion of the third band. The filter can be configured to support the receive portion of the third band.

In some embodiments, the front-end system can further include a multiplexer that includes a first filter configured to support either or both of the first and second bands, and a second filter configured to support the third band, such that a common node of the multiplexer is coupled to the third signal node of the switch network, a node associated with the first filter is coupled to the reconfigurable routing circuit, and a node associated with the second filter is coupled to the third filter-based assembly. In some embodiments, the multiplexer can be implemented as a diplexer. In some embodiments, each of the first and second band can be part of a mid-band having a frequency range of 1695-2200 MHz, and the third band can be part of a high-band having a frequency range of 2300-2690 MHz.

In some embodiments, the reconfigurable routing circuit can include a switch between the node associated with the first filter of the multiplexer and the signal node associated with the selected one of the first and second bands. The selected one of the first and second bands can include either of the first and second bands. The selected one of the first and second bands can include the second band.

In some embodiments, each of the first and second band can be part of a mid-band having a frequency range of 1695-2200 MHz, and the third band can be part of a high-band having a frequency range of 2300-2690 MHz. In some embodiments, each of the first and second band can be part of a mid-band having a frequency range of 1695-2200 MHz, and the third band can have a frequency range below the mid-band.

In some implementations, the present disclosure relates to a packaged module that includes a packaging substrate and a front-end system implemented on the packaging substrate. The front-end system includes a switch network that includes an antenna node, a first signal node connectable to a first filter-based assembly for a first band, a second signal node connectable to a second filter-based assembly for a second band, and a third signal node connectable to a third filter-based assembly for a third band. The switch network is configured to support carrier aggregation of at least the first and second bands. The front-end system further includes a reconfigurable routing circuit configured to allow carrier aggregation of the third band and a selected one of the first and second bands utilizing the third filter-based assembly and the filter-based assembly associated with the selected one of the first and second bands.

In some embodiments, the packaged module can further include the first filter-based assembly connected to the first signal node, the second filter-based assembly connected to the second node, and the third filter-based assembly connected to the third node. Each of the first and second filter-based assemblies can include a duplexer configured to support duplex operation involving transmit and receive portions of the respective band.

In some embodiments, the packaged module can further include a multiplexer that includes a first filter configured to support either or both of the first and second bands, and a second filter configured to support the third band, such that a common node of the multiplexer is coupled to the third signal node of the switch network, a node associated with the first filter is coupled to the reconfigurable routing circuit, and a node associated with the second filter is coupled to the third filter-based assembly.

In some teachings, the present disclosure relates to a wireless device that includes a radio-frequency integrated circuit for processing signals, an antenna, and a front-end system implemented to be electrically between the radio-frequency integrated circuit and the antenna. The front-end system includes a switch network that includes an antenna node, a first signal node connectable to a first filter-based assembly for a first band, a second signal node connectable to a second filter-based assembly for a second band, and a third signal node connectable to a third filter-based assembly for a third band. The switch network is configured to support carrier aggregation of at least the first and second bands. The front-end system further includes a reconfigurable routing circuit configured to allow carrier aggregation of the third band and a selected one of the first and second bands utilizing the third filter-based assembly and the filter-based assembly associated with the selected one of the first and second bands.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts a front-end system having one or more features as described herein, including a feature where an integrated filter associated with one carrier aggregation (CA) mode can be reused for another carrier aggregation mode.

FIG. 2 shows that in some embodiments, the front-end system of FIG. 1 can be implemented in a wireless system.

FIG. 3 shows an example of a front-end system configured to support carrier aggregation of two bands.

FIG. 4 shows an example of a front-end system configured to support carrier aggregation of two bands (Band A and Band B) similar to the example of FIG. 3, plus carrier aggregation of Band B and a third band (Band C).

FIG. 5 shows an example of a front-end system that can be a more specific example of the front-end system of FIG. 1.

FIG. 6 shows a front-end system that can be a more specific example of the front-end system of FIG. 5.

FIG. 7 shows the front-end system of FIG. 6 configured to provide a carrier aggregation operation involving example bands B3 and B32.

FIG. 8 shows the front-end system of FIG. 6 configured to provide a carrier aggregation operation involving example bands B3 and B7.

FIG. 9 shows the front-end system of FIG. 6 configured to provide a carrier aggregation operation involving example bands B1 and B7.

FIG. 10 shows the front-end system of FIG. 6 configured to provide a carrier aggregation operation involving example bands B1, B3 and B7.

FIG. 11 shows a front-end system that is similar to the front-end system of FIG. 6.

FIG. 12 shows that in some embodiments, one or more features as described herein can be implemented in a packaged module.

FIG. 13 depicts an example wireless device having one or more advantageous features described herein.

### DETAILED DESCRIPTION OF SOME EMBODIMENTS

The headings provided herein, if any, are for convenience only and do not necessarily affect the scope or meaning of the claimed invention.

In many communication systems and devices, multi band carrier aggregation are being utilized. Due to the growing band coverage, a cellular device needs to support different band combinations for carrier aggregation, and the complexity of radio-frequency (RF) front-end design increases significantly.

Described herein are examples related to a front-end system that includes a feature where a duplexer in one carrier aggregation (CA) mode can be reused for another carrier aggregation mode. For example, such a front-end system can be configured to reuse a B3 duplexer from a B1 +B3 carrier aggregation mode for a B3+B32 carrier aggregation mode. It will be understood that one or more features of the present disclosure can also reuse a duplexer for other combinations of cellular bands for carrier aggregation operations.

It is noted that traditionally, a diplexer or triplexer can be utilized to multiplex different paths in frequency domain. Then for each carrier aggregation mode, a corresponding duplexer or multiplexer needs to be placed. For example, a pair of B1 and B3 duplexers is added for an example B1+B3 carrier aggregation mode. To support another example B3+B32 carrier aggregation mode, a diplexer needs to be added in front of extra pair of B3+B32 duplexers. Accordingly, such an approach requires two B3 filters and increases design redundancy.

As described herein, one or more features of the present disclosure can be implemented to eliminate or reduce the need of adding duplexer or quadplexer for every carrier aggregation case if there is an appropriate filter already present. For example, a front-end system can be configured to reuse one or more integrated filters associated with one carrier aggregation mode for another carrier aggregation mode. In the example of the B3+B32 carrier aggregation mode, an appropriate switchable connection can be provided to connect a B3 duplexer antenna pin to a B3+B32 diplexer input. Hence, only one B32 duplexer needs to be utilized, and a B3 duplexer can be eliminated.

FIG. 1 depicts a front-end system 100 having one or more features as described herein, including a feature where an integrated filter associated with one carrier aggregation mode can be reused for another carrier aggregation mode. The front-end system 100 is shown to include an assembly of filter-based components 102 such as a plurality of duplexers and one or more diplexers. The front-end system 100 is shown to further include a switching system 104 configured to provide various switching functionalities such as signal routing and aggregation of two or more bands.

In some embodiments, the front-end 100 of FIG. 1 can include a reconfigurable filter/multiplexer system 106 configured to provide one or more functionalities as described herein. Examples related to such a system (106) are described herein in greater detail.

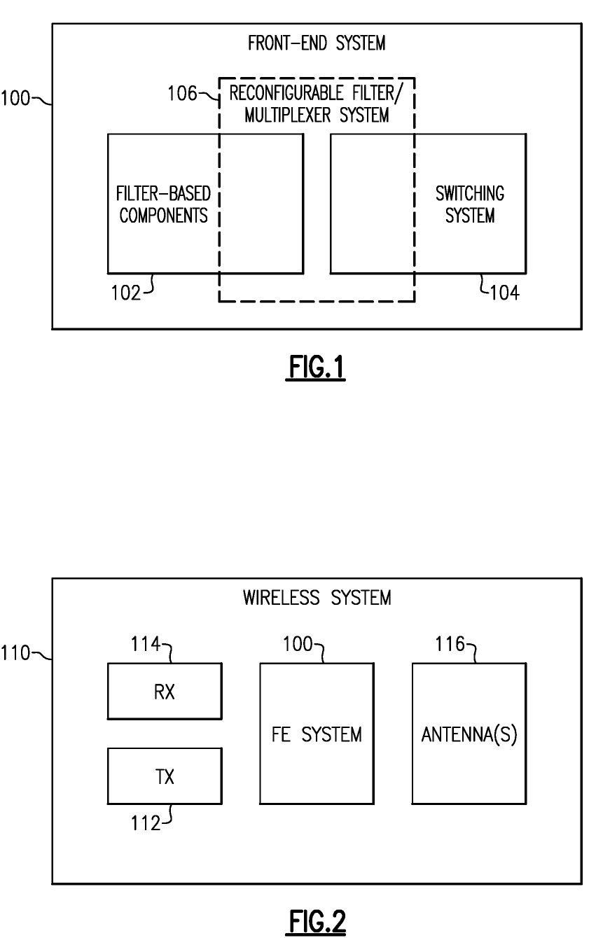

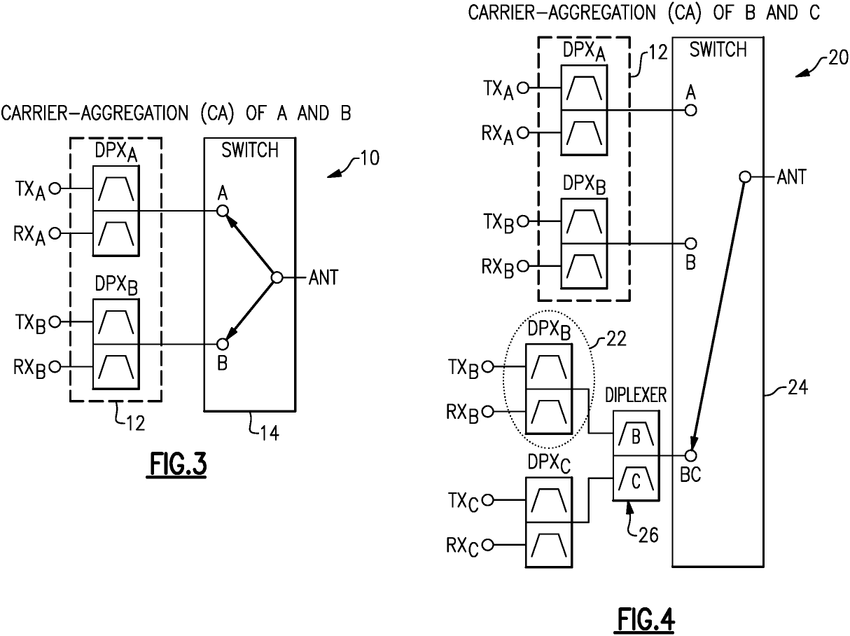

FIG. 2 shows that in some embodiments, the front-end system 100 of FIG. 1 can be implemented in a wireless system 110. Such a wireless system can further include a receive circuitry 114 and/or a transmit circuitry 112, and one or more antennas 116. It will be understood that such a wireless system can be implemented in a wireless device such as a cellular phone.

FIG. 3 shows an example of a front-end system 10 configured to support carrier aggregation of two bands (Band A and Band B). Such a system can include a switch circuit 14 having an antenna node ANT and signal nodes A and B for the two bands A and B, respectively. The signal node A is shown to be coupled to a duplexer DPX_{A} configured to support duplexing of transmit (TX) and receive (RX) operations involving TX and RX frequency ranges associated with Band A. Accordingly, the switch circuit (14) side of the duplexer DPX_{A} is coupled to the signal node A, and the other side of the duplexer DPX_{A} is coupled to Band A TX node (TX_{A}) and to Band A RX node (RX_{A}). Similarly, the signal node B is shown to be coupled to a duplexer DPX_{B} configured to support duplexing of transmit (TX) and receive (RX) operations involving TX and RX frequency ranges associated with Band B. Accordingly, the switch circuit (14) side of the duplexer DPX_{B} is coupled to the signal node B, and the other side of the duplexer DPX_{B} is coupled to Band B TX node (TX_{B}) and to Band B RX node (RX_{B}).

In the example of FIG. 3, the duplexers DPX_{A} and DPX_{B} are collectively indicated as an assembly 12.

FIG. 4 shows an example of a front-end system 20 configured to support carrier aggregation of two bands (Band A and Band B) similar to the example of FIG. 3, plus carrier aggregation of Band B and a third band (Band C). Such a system can include a switch circuit 24 having an antenna node ANT and signal nodes A, B and BC for the bands A, B and aggregated BC, respectively. The signal nodes A and B are shown to be coupled to the assembly 12 of duplexers DPX_{A} and DPX_{B} similar to the example of FIG. 3. The signal node BC is shown to be coupled to a diplexer 26 configured to support aggregation of Band B and Band C. Accordingly, the Band B portion of the diplexer 26 is shown to be coupled to a duplexer DPX_{B} 22 configured to support duplexing of transmit (TX) and receive (RX) operations involving TX and RX frequency ranges associated with Band B, and the Band C portion of the diplexer 26 is shown to be coupled to a duplexer DPXc configured to support duplexing of transmit (TX) and receive (RX) operations involving TX and RX frequency ranges associated with Band C.

In the example front-end 20 of FIG. 4, the duplexer DPX_{B} 22 being utilized for the carrier aggregation of B and C is essentially a duplicate device as the duplexer DPX_{B} being utilized for the carrier aggregation of A and B.

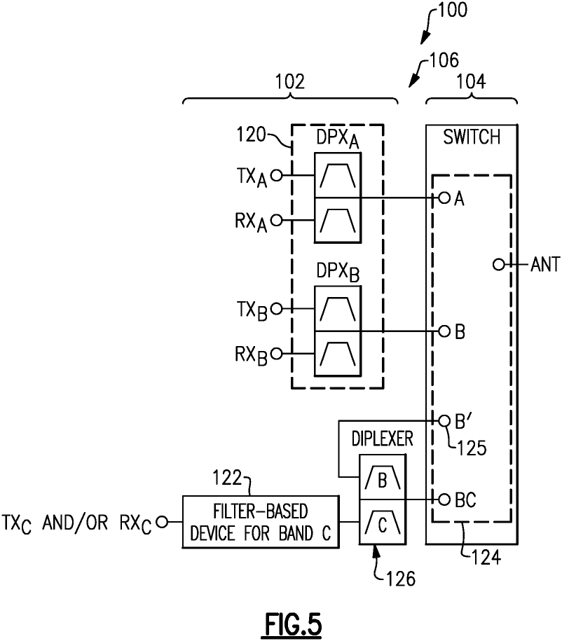

FIG. 5 shows an example of a front-end system 100 that can be a more specific example of the front-end system 100 of FIG. 1. In the example of FIG. 5, a group of filter-based components is generally indicated as 102, and a switching system is generally indicated as 104. In some embodiments, a reconfigurable multiplexing system 106 can include at least a portion of the switching system 104 and various connections between the switching system 104 and the group of filter-based components 102.

The front-end system 100 of FIG. 5 is in an example context of the carrier aggregation functionality of the front-end system of FIG. 4. That is, the front-end system 100 of FIG. 5 is configured to support carrier aggregation operations involving Band A and Band B, as well as Band B and Band C. In FIG. 5, the group of filter-based components 102 is shown to include duplexers DPX_{A} and DPX_{B} (indicated as 120) similar to the example of FIG. 4, as well as a diplexer 126 configured to support aggregation of Band B and Band C. The Band C portion of the diplexer 126 is shown to be coupled to a filter-based device 122 for Band C configured to support transmit (TX) and/or receive (RX) operations involving TX and/or RX frequency ranges associated with Band C. In some embodiments, the filter-based device 122 for Band C can be, for example, a duplexer or a filter.

In the example of FIG. 5, the Band B portion of the diplexer 126 is shown to be coupled to node B' of the switching system 104, where node B' (also indicated as 125) can be coupled to the existing duplexer DPX_{B} of the group of duplexers 120, through node B of the switching system 104. Accordingly, and in contrast to the example of FIG. 4, one duplexer (DPX_{B}) can be utilized for the AB carrier aggregation operation, as well as for the BC carrier aggregation operation. Similarly, node B' can be coupled to the existing duplexer DPX_{A} of the group of duplexers 120, through node A of the switching system 104. Accordingly, one duplexer (DPX_{A}) can be utilized for the AB carrier aggregation operation, as well as for the AC carrier aggregation operation. Examples of such switching/routing functionalities are described herein in greater detail.

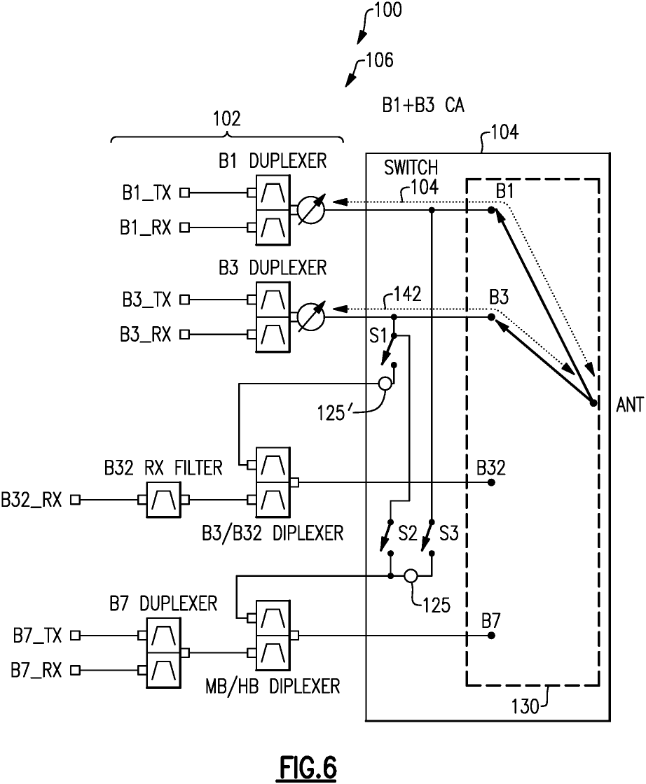

FIG. 6 shows a front-end system 100 that can be a more specific example of the front-end system 100 of FIG. 5. In the example of FIG. 6, specific cellular bands are utilized for the purpose of description; however, it will be understood that other frequency bands can also be utilized for some or all of the front-end system.

Referring to FIGS. 5 and 6, cellular band B1 of FIG. 6 can be Band A of FIG. 5, and cellular band B3 of FIG. 6 can be Band B of FIG. 5. Band C of FIG. 5 can be either cellular band B7 or cellular band B32 in FIG. 6. Accordingly, node B' of FIG. 5 can be either node 125 or node 125' in FIG. 6.

As shown in FIG. 6, such nodes (125 and 125') can be parts of a switching system 104 having an antenna node ANT and signal nodes for the cellular bands B1, B3, B32 and B7. In some embodiments, a portion of the switch system 104 indicated as 130 can be similar to a conventional switch system configured to support the cellular bands B1, B3, B32 and B7. It will be understood that such a switch portion 130 can be operated to connect one or more of the signal nodes (B1, B3, B32 and B7) to the antenna node ANT to support carrier aggregation and non-carrier aggregation operations.

In the example of FIG. 6, the node 125 associated with B7 is shown to be coupled to the signal node B1 through a switch S3. The node 125 associated with B7 is also shown to be coupled to the signal node B3 through a switch S2. The node 125 is also shown to be coupled to a mid-band (MB) (which can include B1 and/or B3) portion of the MB/HB diplexer.

In the example of FIG. 6, the node 125' associated with B32 is shown to be coupled to the signal node B3 through a switch S1. The node 125' is also shown to be coupled to a B3 portion of the B3/B32 diplexer.

Configured in the foregoing manner, the front-end system of FIG. 6 can be utilized to support various non-carrier aggregation and carrier aggregation operations. For example, a non-carrier aggregation operation involving band B1 can be achieved by setting the switch network 104 to connect the antenna node ANT to the signal node B1, and opening each of the switches S1, S2 and S3. In another example, a non-carrier aggregation operation involving band B7 can be achieved by setting the switch network 104 to connect the antenna node ANT to the signal node B7, and opening each of the switches S1, S2 and S3.

FIG. 6 further shows an example of a carrier aggregation operation involving the bands B1 and B3. To support such a carrier aggregation operation, the switch network 104 can be set to connect the antenna node ANT to each of the signal nodes B1 and B3, and opening each of the switches S1, S2 and S3. Configured in such a manner, a signal path 140 is shown to be provided between the antenna node ANT and the common side of the B1 duplexer, and a signal path 142 is shown to be provided between the antenna node ANT and the common side of the B3 duplexer to support the B1/B3 carrier aggregation operation. It will be understood that such a carrier aggregation operation can include an uplink carrier aggregation operation, a downlink carrier aggregation operation, or some combination thereof.

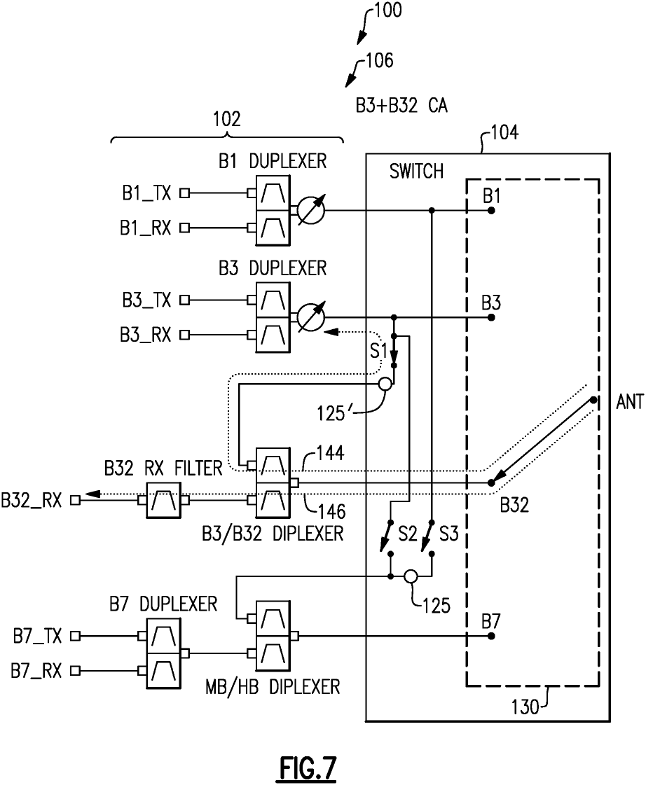

FIG. 7 shows the front-end system 100 of FIG. 6 configured to provide a carrier aggregation operation involving the bands B3 and B32. To support such a carrier aggregation operation, the switch network 104 can be set to connect the antenna node ANT to the signal node B32, closing the switch S1, and opening each of the switches S2 and S3. Configured in such a manner, a signal path 144 is shown to be provided between the antenna node ANT and the common side of the B3 duplexer through the B3 portion of the B3/B32 diplexer, the node 125' and the switch S1. Further, a signal path 146 is shown to be provided between the antenna node ANT and the B32 RX filter through the B32 portion of the B3/B32 diplexer, to support the B3/B32 carrier aggregation operation. In the particular example of FIG. 7, such a carrier aggregation operation can include a downlink carrier aggregation operation.

It is noted that in the example of FIG. 7, the B3/B32 carrier aggregation operation does not include a separate B3 RX filter or a B3 duplexer, since the existing B3 duplexer associated with the B3 signal node is being utilized to support the B3 portion of the B3/B32 carrier aggregation operation.

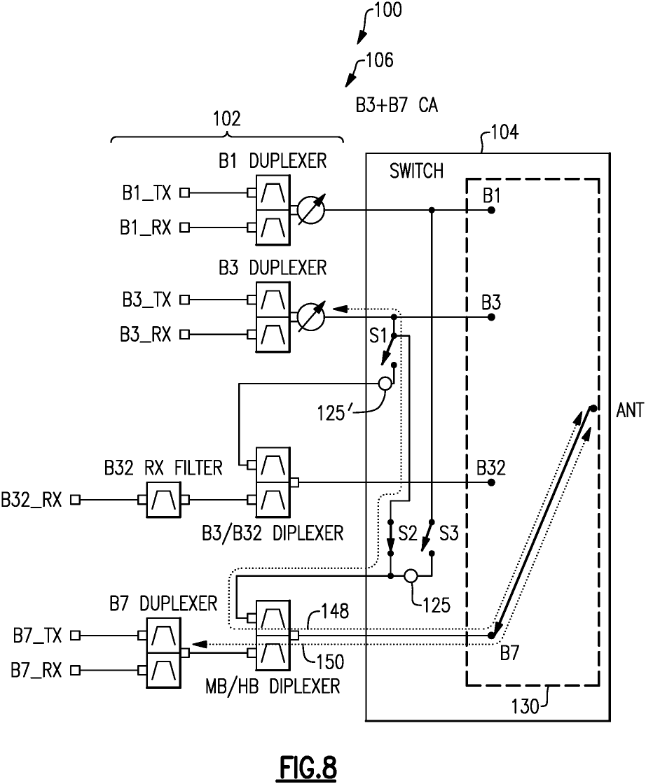

FIG. 8 shows the front-end system 100 of FIG. 6 configured to provide a carrier aggregation operation involving the bands B3 and B7. To support such a carrier aggregation operation, the switch network 104 can be set to connect the antenna node ANT to the signal node B7, closing the switch S2, and opening each of the switches S1 and S3. Configured in such a manner, a signal path 148 is shown to be provided between the antenna node ANT and the common side of the B3 duplexer through the MB portion of the MB/HB diplexer, the node 125 and the switch S2. Further, a signal path 150 is shown to be provided between the antenna node ANT and the common side of the B7 duplexer through the HB portion of the MB/HB diplexer, to support the B3/B7 carrier aggregation operation. In the particular example of FIG. 8, such a carrier aggregation operation can include an uplink carrier aggregation operation, a downlink carrier aggregation operation, or some combination thereof.

It is noted that in the example of FIG. 8, the B3/B7 carrier aggregation operation does not include a separate B3 duplexer, since the existing B3 duplexer associated with the B3 signal node is being utilized to support the B3 portion of the B3/B7 carrier aggregation operation.

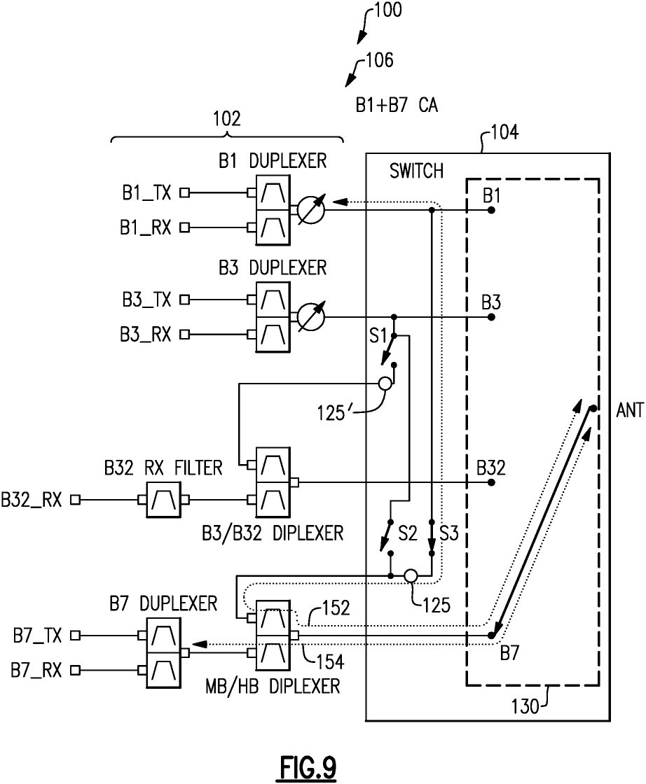

FIG. 9 shows the front-end system 100 of FIG. 6 configured to provide a carrier aggregation operation involving the bands B1 and B7. To support such a carrier aggregation operation, the switch network 104 can be set to connect the antenna node ANT to the signal node B7, closing the switch S3, and opening each of the switches S1 and S2. Configured in such a manner, a signal path 152 is shown to be provided between the antenna node ANT and the common side of the B1 duplexer through the MB portion of the MB/HB diplexer, the node 125 and the switch S3. Further, a signal path 154 is shown to be provided between the antenna node ANT and the common side of the B7 duplexer through the HB portion of the MB/HB diplexer, to support the B1/B7 carrier aggregation operation. In the particular example of FIG. 9, such a carrier aggregation operation can include an uplink carrier aggregation operation, a downlink carrier aggregation operation, or some combination thereof.

It is noted that in the example of FIG. 9, the B3/B7 carrier aggregation operation does not include a separate B1 duplexer, since the existing B1 duplexer associated with the B1 signal node is being utilized to support the B1 portion of the B1/B7 carrier aggregation operation.

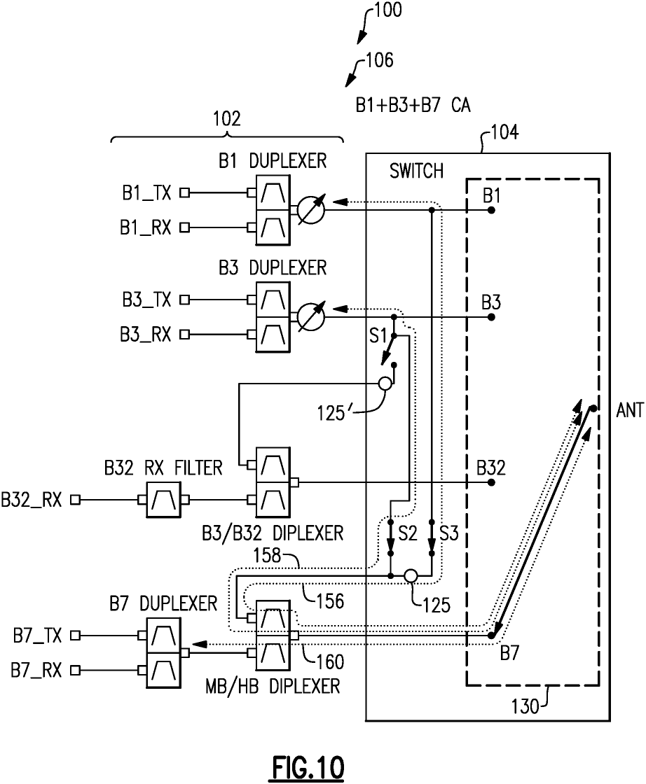

FIG. 10 shows the front-end system 100 of FIG. 6 configured to provide a carrier aggregation operation involving the bands B1, B3 and B7. To support such a carrier aggregation operation, the switch network 104 can be set to connect the antenna node ANT to the signal node B7, closing each of the switches S3 and S2, and opening the switch S1. Configured in such a manner, a signal path 156 is shown to be provided between the antenna node ANT and the common side of the B1 duplexer through the MB portion of the MB/HB diplexer, the node 125 and the switch S3; a signal path 158 is shown to be provided between the antenna node ANT and the common side of the B3 duplexer through the MB portion of the MB/HB diplexer, the node 125 and the switch S3; and a signal path 160 is shown to be provided between the antenna node ANT and the common side of the B7 duplexer through the HB portion of the MB/HB diplexer, to support the B1/B3/B7 carrier aggregation operation. In the particular example of FIG. 10, such a carrier aggregation operation can include an uplink carrier aggregation operation, a downlink carrier aggregation operation, or some combination thereof.

It is noted that in the example of FIG. 10, the carrier aggregation operation does not include a separate B1 duplexer or a separate B3 duplexer, since the existing B1 duplexer associated with the B1 signal node is being utilized to support the B1 portion of the carrier aggregation operation, and the existing B3 duplexer associated with the B3 signal node is being utilized to support the B3 portion of the carrier aggregation operation.

In the example front-end system 100 of FIG. 6, each of the B1 and B3 signal paths (e.g., between the signal node of the switch system 104 and the respective duplexer) is shown to include a phase shifter. Such a phase shifter can be provided and configured to support a carrier aggregation operation involving the respective band. It will be understood that a signal path associated with a given band may or may not include a phase shifter.

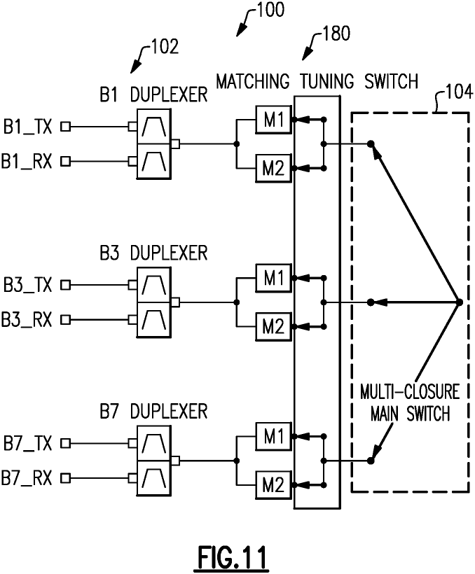

FIG. 11 shows a front-end system 100 that is similar to the front-end system 100 of FIG. 6. However, FIG. 11 shows that in some embodiments, a front-end system having one or more features as described herein can include a matching network 180 configured to provide impedance matching between the filter-based components 102 (such as duplexers) and the switch system (104), for some or all of the bands.

For example, and referring to FIG. 11, the matching network 180 is shown to include matching circuits M1 and M2 tuned to TX and RX frequency bands of the B1 band. Similarly, for each of the B3 and B7 bands, matching circuits M1 and M2 can be provided and tuned to TX and RX frequency bands of the respective band.

FIG. 12 shows that in some embodiments, one or more features as described herein can be implemented in a packaged module 400. Such a packaged module can include a packaging substrate 402 configured to receive a plurality of components. At least some of the components mounted on the packaging substrate 402 can include an assembly of filter-based components 102 and a switch network 104 as described herein. In some embodiments, some or all of the switch network 104 can be implemented on a semiconductor die 300 such as a silicon-on-insulator (SOI) die.

In some implementations, a device and/or a circuit having one or more features described herein can be included in an RF device such as a wireless device. Such a device and/or a circuit can be implemented directly in the wireless device, in a modular form as described herein, or in some combination thereof. In some embodiments, such a wireless device can include, for example, a cellular phone, a smart-phone, a hand-held wireless device with or without phone functionality, a wireless tablet, etc.

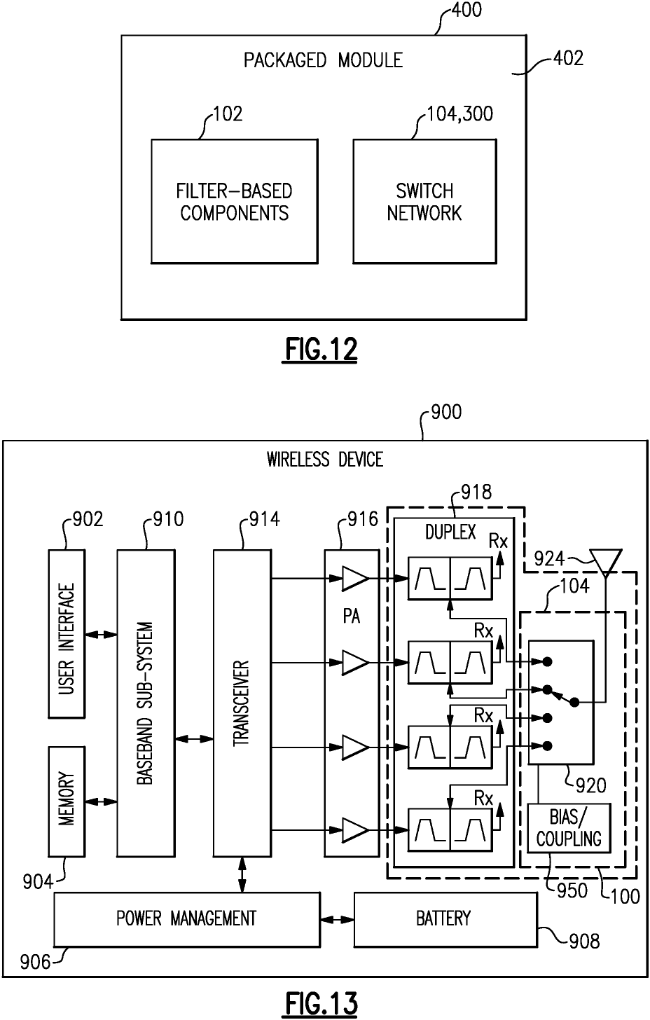

FIG. 13 depicts an example wireless device 900 having one or more advantageous features described herein. In some embodiments, a front-end system generally indicated as 100 can be implemented for the wireless device 900.

In the example wireless device 900, a power amplifier (PA) assembly 916 having a plurality of PAs can provide one or more amplified RF signals to the switch 920 (via an assembly of one or more duplexers 918), and the switch 920 can route the amplified RF signal(s) to one or more antennas. The PAs 916 can receive corresponding unamplified RF signal(s) from a transceiver 914 that can be configured and operated in known manners. The transceiver 914 can also be configured to process received signals. The transceiver 914 is shown to interact with a baseband sub-system 910 that is configured to provide conversion between data and/or voice signals suitable for a user and RF signals suitable for the transceiver 914. The transceiver 914 is also shown to be connected to a power management component 906 that is configured to manage power for the operation of the wireless device 900. Such a power management component can also control operations of the baseband sub-system 910 and the module 910.

The baseband sub-system 910 is shown to be connected to a user interface 902 to facilitate various input and output of voice and/or data provided to and received from the user. The baseband sub-system 910 can also be connected to a memory 904 that is configured to store data and/or instructions to facilitate the operation of the wireless device, and/or to provide storage of information for the user.

In some embodiments, the duplexers 918 can allow transmit and receive operations to be performed simultaneously using a common antenna (e.g., 924). In FIG. 13, received signals are shown to be routed to "Rx" paths that can include, for example, one or more low-noise amplifiers (LNAs).

A number of other wireless device configurations can utilize one or more features described herein. For example, a wireless device does not need to be a multi-band device. In another example, a wireless device can include additional antennas such as diversity antenna, and additional connectivity features such as Wi-Fi, Bluetooth, and GPS.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." The word "coupled", as generally used herein, refers to two or more elements that may be either directly connected, or connected by way of one or more intermediate elements. Additionally, the words "herein," "above," "below," and words of similar import, when used in this application, shall refer to this application as a whole and not to any particular portions of this application. Where the context permits, words in the above Description using the singular or plural number may also include the plural or singular number respectively. The word "or" in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A front-end system comprising:
a switch network that includes an antenna node, a first signal node connectable to a first filter-based assembly for a first band, a second signal node connectable to a second filter-based assembly for a second band, and a third signal node connectable to a third filter-based assembly for a third band, the switch network configured to support carrier aggregation of at least the first and second bands; and
a reconfigurable routing circuit configured to allow carrier aggregation of the third band and a selected one of the first and second bands utilizing the third filter-based assembly and the filter-based assembly associated with the selected one of the first and second bands.

2. The front-end system of claim 1 further comprising the first filter-based assembly connected to the first signal node, the second filter-based assembly connected to the second node, and the third filter-based assembly connected to the third node.

3. The front-end system of claim 1 wherein at least a portion of the reconfigurable routing circuit is part of the switch network.

4. The front-end system of claim 1 wherein each of the first and second filter-based assemblies includes a duplexer configured to support duplex operation involving transmit and receive portions of the respective band.

5. The front-end system of claim 4 wherein the third filter-based assembly includes a duplexer configured to support duplex operation involving transmit and receive portions of the third band.

6. The front-end system of claim 4 wherein the third filter-based assembly includes a filter configured to support a transmit or receive portion of the third band.

7. The front-end system of claim 6 wherein the filter is configured to support the receive portion of the third band.

8. The front-end system of claim 1 further comprising a multiplexer that includes a first filter configured to support either or both of the first and second bands, and a second filter configured to support the third band, such that a common node of the multiplexer is coupled to the third signal node of the switch network, a node associated with the first filter is coupled to the reconfigurable routing circuit, and a node associated with the second filter is coupled to the third filter-based assembly.

9. The front-end system of claim 8 wherein the multiplexer is implemented as a diplexer.

10. The front-end system of claim 8 wherein each of the first and second band is part of a mid-band having a frequency range of 1695-2200 MHz, and the third band is part of a high-band having a frequency range of 2300-2690 MHz.

11. The front-end system of claim 8 wherein the reconfigurable routing circuit includes a switch between the node associated with the first filter of the multiplexer and the signal node associated with the selected one of the first and second bands.

12. The front-end system of claim 11 wherein the selected one of the first and second bands includes either of the first and second bands.

13. The front-end system of claim 11 wherein the selected one of the first and second bands includes the second band.

14. The front-end system of claim 8 wherein each of the first and second band is part of a mid-band having a frequency range of 1695-2200 MHz, and the third band is part of a high-band having a frequency range of 2300-2690 MHz.

15. The front-end system of claim 8 wherein each of the first and second band is part of a mid-band having a frequency range of 1695-2200 MHz, and the third band has a frequency range below the mid-band.

16. A packaged module comprising:
a packaging substrate; and
a front-end system implemented on the packaging substrate and including a switch network that includes an antenna node, a first signal node connectable to a first filter-based assembly for a first band, a second signal node connectable to a second filter-based assembly for a second band, and a third signal node connectable to a third filter-based assembly for a third band, the switch network configured to support carrier aggregation of at least the first and second bands, the front-end system further including a reconfigurable routing circuit configured to allow carrier aggregation of the third band and a selected one of the first and second bands utilizing the third filter-based assembly and the filter-based assembly associated with the selected one of the first and second bands.

17. The packaged module of claim 16 further comprising the first filter-based assembly connected to the first signal node, the second filter-based assembly connected to the second node, and the third filter-based assembly connected to the third node.

18. The packaged module of claim 17 wherein each of the first and second filter-based assemblies includes a duplexer configured to support duplex operation involving transmit and receive portions of the respective band.

19. The packaged module of claim 16 further comprising a multiplexer that includes a first filter configured to support either or both of the first and second bands, and a second filter configured to support the third band, such that a common node of the multiplexer is coupled to the third signal node of the switch network, a node associated with the first filter is coupled to the reconfigurable routing circuit, and a node associated with the second filter is coupled to the third filter-based assembly.

20. A wireless device comprising:
a radio-frequency integrated circuit for processing signals;
an antenna; and
a front-end system implemented to be electrically between the radio-frequency integrated circuit and the antenna, the front-end system including a switch network that includes an antenna node, a first signal node connectable to a first filter-based assembly for a first band, a second signal node connectable to a second filter-based assembly for a second band, and a third signal node connectable to a third filter-based assembly for a third band, the switch network configured to support carrier aggregation of at least the first and second bands, the front-end system further including a reconfigurable routing circuit configured to allow carrier aggregation of the third band and a selected one of the first and second bands utilizing the third filter-based assembly and the filter-based assembly associated with the selected one of the first and second bands.
